(19) United States
(12) Patent Application Publication
(10) Pub. No.: US 2008/0126950 A1
(43) Pub. Date: May 29, 2008

(54) Smart Reply Function on Web Pages

(76) Inventors: Patrick Leo Glenski, Rochester, MN (US); Thomas Marcus McBride, Mantorville, MN (US); Michael Francis Moriarty, Byron, MN (US)

Correspondence Address: IBM CORPORATION (SS/ROC);c/o STREETS & STEELE, 13831 NORTHWEST FREEWAY, SUITE 355, HOUSTON, TX, 77040, US

(21) Appl. No.: 11/563,876

(22) Filed: Nov. 28, 2006

(51) Int. Cl. G06F 15/16; G06F 3/048

(52) U.S. Cl. 715/752; 709/206

(57) ABSTRACT

Method and computer program product for interacting with a website to obtain an electronic message (“e-mail”) address associated with the website's web address. A “smart reply” function is provided, optionally as part of a conventional web browser to provide a consistent user interface. The method includes identifying and obtaining an electronic message address that is associated with the web address, such as the URL in the browser address bar. Having identified a web address, steps are taken toward obtaining an associated e-mail address, preferably including searching a prioritized listing of sources from which an associated e-mail address may be found. These sources may include, without limitation, a database previously populated by the user, the website identified by the URL, the DNS, and a search engine.

### BACKGROUND OF THE INVENTION

1. Field of the Invention

The present invention relates to the interaction of a web browser with a website.

2. Background of the Related Art

A web browser is a software application that enables a user to display and interact with text, images, and other information typically located on a web page at a website on the World Wide Web or a local area network. Text and images on a web page can contain hyperlinks to other web pages at the same or different websites. Web browsers allow a user to quickly and easily access information provided on many web pages at many websites by traversing these links.

Web browsers available for personal computers include Microsoft Internet Explorer, Mozilla Firefox, Apple Safari, Netscape, and Opera. Web browsers are the most commonly used type of HTTP user agent. Although browsers are typically used to access the World Wide Web, they can also be used to access information provided by web servers in private networks or content in file systems.

Web browsers communicate with web servers primarily using HTTP (hypertext transfer protocol) to fetch web pages. HTTP allows web browsers to submit information to web servers as well as fetch web pages from them. The most commonly used HTTP is HTTP/1.1, which is fully defined in RFC 2616.

Pages are located by means of a URL (uniform resource locator), which is treated as an address, beginning with http: for HTTP access. Many browsers also support a variety of other URL types and their corresponding protocols, such as ftp: for FTP (file transfer protocol), rtsp: for RTSP (real-time streaming protocol), and https: for HTTPS (an SSL encrypted version of HTTP).

The file format for a web page is usually HTML (hyper-text markup language) and is identified in the HTTP protocol using a MIME content type. Most browsers natively support a variety of formats in addition to HTML, such as the JPEG, PNG and GIF image formats, and can be extended to support more through the use of plug-ins. The combination of HTML content type and URL protocol specification allows web page designers to embed images, animations, video, sound, and streaming media into a web page, or to make them accessible through the web page.

Modern web browsers support standards-based HTML and XHTML, which should display in the same way across all browsers. Currently many sites are designed using WYSIWYG HTML generation programs such as Macromedia Dreamweaver or Microsoft Frontpage. These programs often generate non-standard HTML by default, hindering the work of the W3C in developing standards, specifically with XHTML and CSS (cascading style sheets, used for page layout).

Some of the more popular browsers include additional components to support Usenet news, IRC (Internet relay chat), and e-mail. Protocols supported may include NNTP (network news transfer protocol), SMTP (simple mail transfer protocol), IMAP (Internet message access protocol), and POP (post office protocol). These browsers are often referred to as Internet suites or application suites rather than merely web browsers.

Many websites include user-friendly features such as the ability to submit a message to the webmaster or other individuals or departments associated with the website. The ability to submit an electronic message may be beneficially used in many contexts, including the submission of questions about a consumer product, requests for more information about a product or service, or commenting on the website content. However, whether a website includes a “reply to us” or “contact us” feature or page is at the discretion of the website owner or the ability or budget of the website developer. Therefore, a user's ability to send a message to someone affiliated with a website is uncertain.

Still further, even if the website provides features to facilitate submission of a message, the user must navigate the website to find and use the feature. Variations in the implementation of message submission features can inhibit users from making frequent use of these features.

Therefore, there is a need for a standardized method for submitting an electronic message to an address affiliated with a website. It would be desirable if the method was available to the web browser user regardless of whether target websites implement such an automated feature into their website. It would also be desirable if the method provided a consistent user interface for generating and sending the electronic message.

### SUMMARY OF THE INVENTION

The present invention provides a method and a computer program product including instructions embodied on a computer readable medium for obtaining an electronic message address associated with a web address. The instructions of the computer program product comprise instructions for identifying a target web address; instructions for searching one or more source in order to identify and obtain an electronic message address, wherein the one or more source is selected from content of a website at the web address, a remote third party server containing an electronic message address registered in association with the root web address of the website, and a combination thereof; instructions for initiating an electronic message template; and instructions for inserting an identified electronic message address into the electronic message template as the destination address. In one embodiment, the computer program product further comprises instructions for displaying each electronic message address identified and obtained; and instructions for allowing a user to select which displayed electronic message address to insert into the electronic message template. In another embodiment, the instructions for searching one or more source include instructions for searching the content of the website, and further include instructions for identifying code in the website implementing an electronic message form or an electronic message link.

### BRIEF DESCRIPTION OF THE DRAWINGS

FIG. 1 is a schematic diagram of a Web application server in communication with a computer system through a network.

FIG. 2 is a computer system having various typical input and output devices.

FIG. 3 is a schematic diagram of a computer system having a browser and network access for interacting with the Web application server.

FIGS. 4A and 4B provide a flowchart of a method for interacting with a website to obtaining an e-mail address associated with a web address.

### DETAILED DESCRIPTION

The present invention provides a method and computer program product for interacting with a website over a network to obtain an electronic message (“e-mail”) address associated with a web address associated with the website. The web address may be the same as that of the website that is currently selected by an active browser window, a web address designated by the currently selected website, or a web address manually entered by the user into the browser. Furthermore, the e-mail address should be directly associated with the web address. Non-limiting examples of a directly associated e-mail address include an e-mail address found in code establishing an e-mail form or e-mail link at the web address, an e-mail address found in text at the web address, or an e-mail address registered with a domain name system (DNS) in association with the web address, such as the root web address.

In one embodiment, the method enables a “smart reply” function to be added to a conventional web browser. This “smart reply” feature may be a standard browser based plug-in for use with any browser. This “smart reply” feature will greatly simplify the task of sending a message to a web owner. A consistent “view” or user interface for the reply function will enable web users to better take advantage of the power of the web.

The method includes identifying and obtaining an electronic message address that is associated with the web address. When the method has been implemented by a web browser, the web address may be the URL in the browser address bar. Furthermore, the method may be implemented by a web browser, e-mail program or search engine by providing a search entry screen for input of the URL. Thereafter, a “search” button or “search special” button may be activated to initiate a search for an associated e-mail address, without having to actually browse to the website identified by the URL.

Having identified a web address, it is then possible to take steps toward obtaining an associated e-mail address. The inclusion and order of these steps may vary from application to application, but preferably include searching a prioritized listing of sources from which one or more associated e-mail address may be found. These sources may include, without limitation, a database previously populated by the user, the website identified by the URL, the DNS, and a search engine.

In one embodiment, the user may input an e-mail address that the user wants to use in association with the website. Accordingly, the user may customize the smart reply feature, optionally overriding the default email for any given URL, so that future replies are sent to the e-mail address provided by the user. The tool could store the e-mail address in a database record along with the web address of the website. The database is preferably stored locally on the same computer or network as the tool that is being used. During subsequent visits to the same website, the user can simply initiate the smart reply of the tool. The tool will identify the active web address and search the database for matching entries. If one or more match or near match are found, the associated e-mail address(es) can be offered to the user for final selection, such as by listing the stored e-mail address(es) in a drop down box. The user may select or accept an e-mail address by clicking on the appropriate address. This click will open a window for an e-mail application program and initiate an e-mail message addressed to the selected e-mail address. It is generally preferred that user-entered e-mail addresses be given greater priority than those found from either a search of the website or the DNS.

In a further embodiment, the website associated with the identified web address is searched for one or more e-mail address. In one aspect of a website search, the method may look for standard HTML code for implementing either a link to email or an e-mail form. A link to email is commonly programmed with an <A HREF> tag identifying an e-mail address, such as the tag <A HREF=“mailto:customerservice@company.com”>. An HTML form may, for example, be identified by the beginning <FORM> tag and the ending </FORM> tag, and an e-mail form will typically include an ACTION attribute identifying an e-mail address, such as <FORM ACTION=“mailto:customerservice@company.com”></FORM>. The search may look for other tags or code that may be know, or may become known, for submission of messages via a website.

In a further embodiment, the DNS may be queried to obtain an e-mail address that is associated with the registration of the domain name within the web address. For example, if the address bar of an active browser window included the address “http://www.alsa.org/research/article.cfm?id=643”, then the DNS would be queried for an e-mail address associated with the registrant of the domain name alsa.org. In the alternative, a third party website containing e-mail addresses associated with domain names could be accessed.

In yet another embodiment, a combination of the foregoing sources may each be searched. Such searching may be carried out effectively simultaneously or sequentially to obtain one or more e-mail address from which the user may select. Preferably, the user will be presented with the one or more e-mail address and a brief identification of the source from which each address came so that the user could judge the likelihood that the e-mail address will be directed as desired. For example, a retail website may be a suitable source for an e-mail address directed to a customer service department, but the DNS may be a better source for an e-mail address directed to the information technology department of the same company. Preferably, the combination of sources will give the highest priority to any user-entered e-mail address, since the user has presumably previously gone through the process of determining that this particular e-mail address served their purpose with respect to a given website. For most purposes, the next highest priority should probably be given to e-mail addresses found on the website itself.

Once an e-mail address has been selected, an e-mail template may be initiated, for example using an email application program on the browsing computer. It is preferred to automatically insert the e-mail address into the electronic message template as the destination address. Depending upon the information obtained along with the selected e-mail address, the e-mail template may also be populated with additional information, such as a subject description, message text, and so on. As previously described, this additional information may be found in an e-mail link or an e-mail form attribute. However, after the email template has been initiated, the user may delete, edit, or enter additional information into the template as desired.

The method allows a user to use a consistent “reply to” function of a browser rather than filling out a web site's “contact us” form. Since the message is generated on the user's own computer, rather than on the web site's server, the user gains control over the user interface, optional automation and tools, and storage of historical information about the message sent.

The embodiments of the invention may take the form of a computer program product including instructions embodied on a computer readable medium. Non-limiting examples of such a computer program product include a browser application program, an e-mail application program, or an application program plug-in for use with a browser or e-mail application program. The application program or plug-in may be written in various computer languages, including Java.

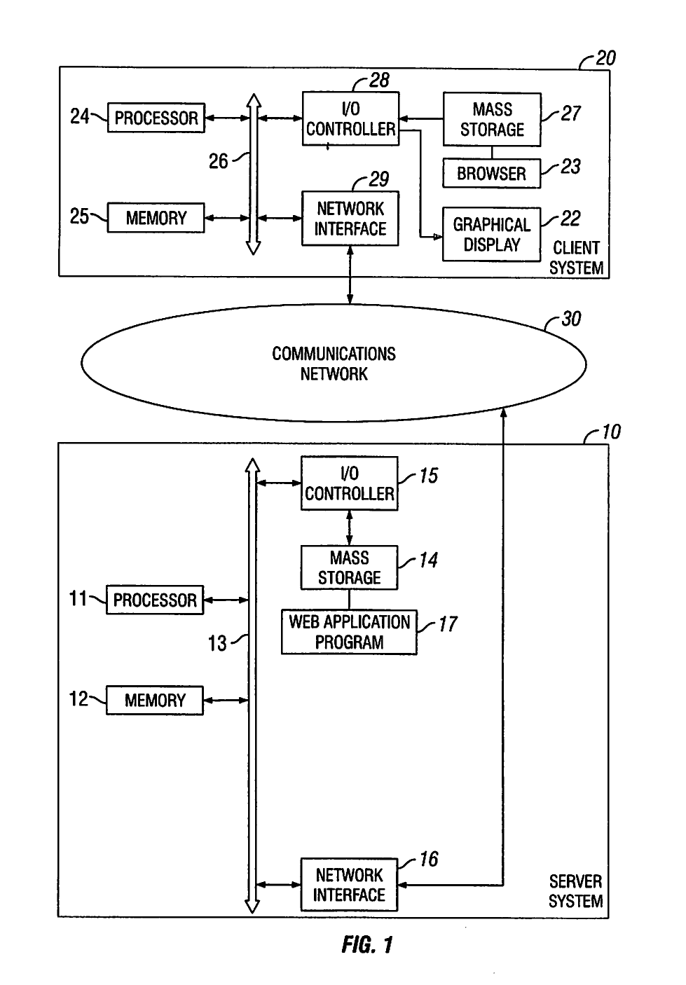

FIG. 1 is a schematic diagram of a Web application server system 10 in communication with an individual user's computer 20 through a network, such as the Internet 30. The user's computer 20 includes conventional components such as a processor 24, memory 25 (e.g. RAM), a bus 26 which couples the processor 24 and memory 25, a mass storage device 27 (e.g. a magnetic hard disk or an optical storage disk) coupled to the processor and memory through an I/O controller 28 and a network interface 29, such as a conventional modem. The Web application server system 10 also includes conventional components such as a processor 11, memory 12 (e.g. RAM), a bus 13 which couples the processor 11 and memory 12, a mass storage device 14 (e.g. a magnetic or optical disk) coupled to the processor 11 and memory 12 through an I/O controller 15 and a network interface 16, such as a conventional modem.

It should be appreciated that the present invention may be implemented in software that is stored as executable instructions on a computer readable medium on the client system 20, such as in mass storage device 27 or in memory 25 as part of the browser 23. The Web application server system 10 is shown having a Web application program 17 that embodies a web site.

The communications network 30 is the medium used to provide communications links between the Web application server 10 and any number of various devices and computers (individually represented as computer 20). The communications network 30 may include permanent connections, such as wire or fiber optic cables, or temporary connections made through telephone or wireless communications. A registered user's computer and the Web application server may be represented by a variety of types of computing devices, such as mainframes, personal computers, personal digital assistants (PDAs), smart phones, etc. The server system may include additional servers, clients, routers and other devices not shown. In the example of FIG. 1, the network system 30 may include the Internet (a worldwide collection of networks and gateways that use the TCP/IP suite of protocols to communicate with one another). Of course, the Web application server 10 may also communicate over a number of different types of networks, such as, for example, an intranet, a local area network (LAN), or a wide area network (WAN).

The present invention can be implemented on a variety of hardware platforms and can be implemented in a variety of software environments. A typical operating system may be used to control program execution within the data processing system. Furthermore, although the preferred embodiment described below includes a “browser” 23 at the user's computer as the agent that exchanges data with the Web application server, the agent at the registered user's computer does not have to be a conventional browser, such as Netscape Navigator® or Microsoft Internet Explorer®. The Web application server 10 preferably operates a conventional server software program 21, such as International Business Machines' WebSphere®, for administering the Web application program.

The computer network 30 may be the Internet, an intranet, or other network. The server 10 may be a Web application server (WAS), a server application, a servlet process or the like. Optionally, the user's device 20 is used to identify and obtain e-mail addresses associated with the web site, allow the user to select an e-mail address, and initiate an e-mail message template directed to the e-mail address. The user's device 20 may also include a database that contains records for each user-entered e-mail address that is used in association with a website.

It should be recognized that the invention may take the form of an entirely hardware embodiment, an entirely software embodiment, or an embodiment containing both hardware and software elements. In particular embodiments, including those embodiments of methods, the invention may be implemented in software, which includes but is not limited to firmware, resident software and microcode.

Furthermore, the invention can take the form of a computer program product accessible from a computer-readable medium providing program code for use by or in connection with a computer or any instruction execution system. For the purposes of this description, a computer-usable or computer-readable medium can be any apparatus that can contain, store, communicate, propagate or transport the program for use by or in connection with the instruction execution system, apparatus or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD-read only memory (DVD-ROM), and DVD-read/write (DVD-R/W).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

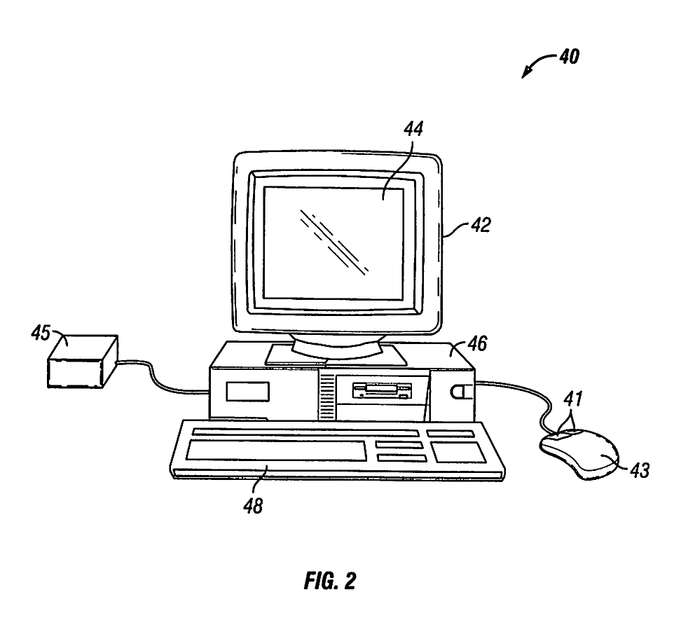

FIG. 2 is a computer system having various typical input and output devices, suitable to serve as the client system 20 of FIG. 1. The computer system 40 includes a display device 42 (such as a monitor), a display screen 44, a cabinet 46 (which encloses components typically found in a computer, such as CPU, RAM, ROM, video card, hard drive, sound card, serial ports, etc.), a keyboard 48, a mouse 43 and a modem 45. The mouse 43 may have one or more buttons, such as buttons 41. The computer requires some type of communication device such as modem 45 that allows computer system 40 to be connected to the Internet. Other possible communication devices include Ethernet network cards. This computer system is just one example of a suitable client system and should be not be viewed as limiting the architecture that is compatible with the invention.

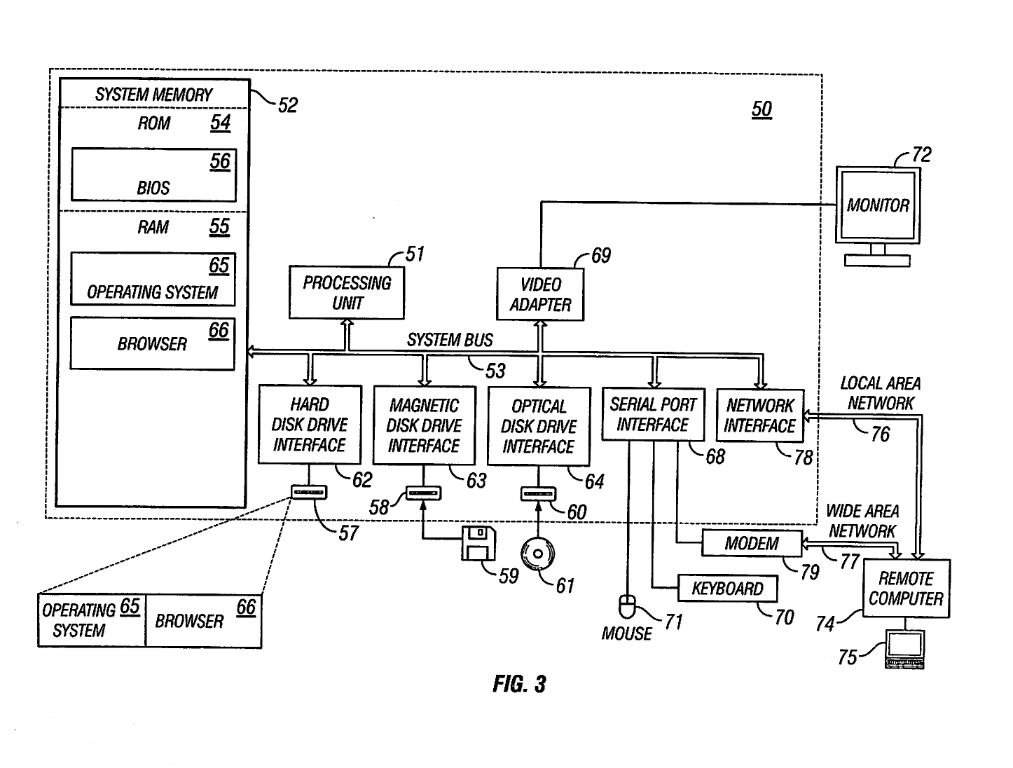

FIG. 3 is a schematic diagram of a computer system 50 that is capable of running a browser. The system 50 may be a general-purpose computing device in the form of a conventional personal computer 50. Generally, a personal computer 50 includes a processing unit 51, a system memory 52, and a system bus 53 that couples various system components including the system memory 52 to processing unit 51. System bus 53 may be any of several types of bus structures including a memory bus or memory controller, a peripheral bus, and a local bus using any of a variety of bus architectures. The system memory includes a read-only memory (ROM) 54 and random-access memory (RAM) 55. A basic input/output system (BIOS) 56, containing the basic routines that help to transfer information between elements within personal computer 50, such as during start-up, is stored in ROM 54.

Computer 50 further includes a hard disk drive 57 for reading from and writing to a hard disk 57, a magnetic disk drive 58 for reading from or writing to a removable magnetic disk 59, and an optical disk drive 60 for reading from or writing to a removable optical disk 61 such as a CD-ROM or other optical media. Hard disk drive 57, magnetic disk drive 58, and optical disk drive 60 are connected to system bus 53 by a hard disk drive interface 62, a magnetic disk drive interface 63, and an optical disk drive interface 64, respectively. Although the exemplary environment described herein employs hard disk 57, removable magnetic disk 59, and removable optical disk 61, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for computer 50. For example, the operating system 65 and application programs, such as a Web browser 66, may be stored in the RAM 55 and/or hard disk 57 of the computer 50.

A user may enter commands and information into personal computer 50 through input devices, such as a keyboard 70 and a pointing device, such as a mouse 71. Other input devices (not shown) may include a microphone, joystick, game pad, satellite dish, scanner, or the like. These and other input devices are often connected to processing unit 51 through a serial port interface 68 that is coupled to the system bus 53, but input devices may be connected by other interfaces, such as a parallel port, game port, a universal serial bus (USB), or the like. A display device 72 may also be connected to system bus 53 via an interface, such as a video adapter 69. In addition to the monitor, personal computers typically include other peripheral output devices (not shown), such as speakers and printers.

The computer 50 may operate in a networked environment using logical connections to one or more remote computers 74. Such a remote computer 74 may be another personal computer, a server, a client, a router, a network PC, a peer device, a mainframe, a personal digital assistant, an Internet-connected mobile telephone or other common network node. While a remote computer 74 typically includes many or all of the elements described above relative to the computer 50, only a display device 75 has been illustrated in the figure. The logical connections depicted in the figure include a local area network (LAN) 76 and a wide area network (WAN) 77. Such networking environments are commonplace in offices, enterprise-wide computer networks, intranets, and the Internet.

When used in a LAN networking environment, the computer 50 is often connected to the local area network 76 through a network interface or adapter 78. When used in a WAN networking environment, the computer 50 typically includes a modem 79 or other means for establishing high-speed communications over WAN 77, such as the Internet. A modem 79, which may be internal or external, is connected to system bus 53 via serial port interface 68. In a networked environment, program modules depicted relative to personal computer 50, or portions thereof, may be stored in the remote memory storage device 75. It will be appreciated that the network connections shown are exemplary and other means of establishing a communications link between the computers may be used. A number of program modules may be stored on hard disk 57, magnetic disk 59, optical disk 61, ROM 54, or RAM 55, including an operating system 65 and browser 66.

The described example shown in FIG. 2 does not imply architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

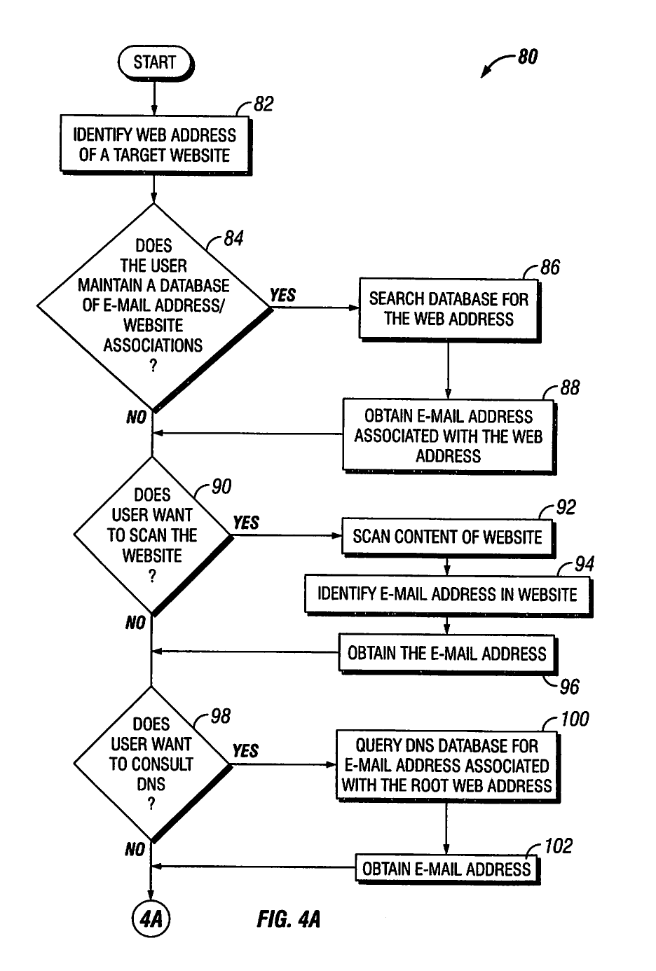

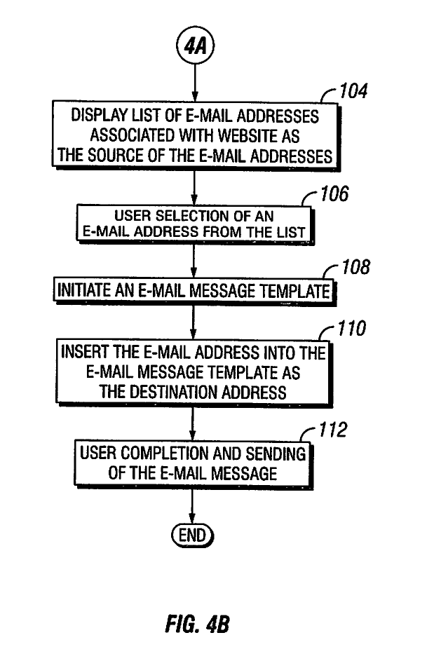

FIGS. 4A and 4B provide a flowchart of a method 80 for interacting with a website to obtaining an e-mail address associated with a web address associated with the website. In state 82, the web address of a target website is identified. The target website may be the URL located in the address bar of a web browser application program. In state 84, it is determined whether the user maintains a database of websites and associated e-mail addresses. If such a database is available, then the database is searched to see if it contains an entry for the web address in state 86, and the e-mail address associated with the web address is obtained in state 88.

After obtaining the e-mail address from the database or if no database is maintained, then state 90 determined whether the user wants to scan the website for one or more e-mail address. If this is desired, then the content of the website is scanned in state 92, e-mail addresses (if any) from the website are identified in state 94, and an e-mail address may be obtained in state 96. It should be recognized that the website may not contain any number of e-mail addresses, such as none, one or multiple e-mail address.

After attempting to obtain an e-mail address from the website in states 92, 94, 96 or determining not to do so in state 90, it is determined in state 98 whether to consult the Domain Name System (DNS) for an e-mail address of the registrant to the domain name of the website. If so, then in state 100 the DNS is queried to for an e-mail address associated with the root web address of the website. If such an e-mail address exists, then it is obtained in state 102.

Having potentially obtained e-mail addresses from a user database, the website, and the DNS, state 104 then displays a list of the associated e-mail addresses and the source of each address. In state 106, the user selects an e-mail address from the list. An e-mail message template is initiated in state 108, followed by insertion of the selected e-mail address into the e-mail message template as the destination address in state 110. The user can them complete and send the e-mail message in state 112.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

What is claimed is:

1. A computer program product including instructions embodied on a computer readable medium for obtaining an electronic message address associated with a web address, the instructions comprising:
instructions for identifying a target web address;
instructions for searching one or more sources in order to identify and obtain an electronic message address, wherein the one or more sources are selected from content of a website at the web address, a remote third party server containing an electronic message address registered in association with the root web address of the website, and a combination thereof;
instructions for initiating an electronic message template; and
instructions for inserting an identified electronic message address into the electronic message template as the destination address.

2. The computer program product of claim 1, wherein the remote third party server is a Domain Name System server.

3. The computer program product of claim 1, further comprising:
instructions for displaying each electronic message address identified and obtained; and
instructions for allowing a user to select which displayed electronic message address to insert into the electronic message template.

4. The computer program product of claim 1, wherein the instructions for searching one or more sources include instructions for searching the content of the website, and further include instructions for identifying code in the website implementing an electronic message form or an electronic message link.

5. The computer program product of claim 4, further comprising instructions for locating an electronic message address within the identified code.

6. The computer program product of claim 1, wherein the instructions are included in a browser or browser plug-in, and wherein the instructions further comprise instructions for providing a selectable browser menu function that initiates the step of searching one or more sources.

7. The computer program product of claim 1, wherein the instructions for searching one or more sources include instructions for querying the remote third party server only if an electronic message address is not identified and obtained from the website content.

8. The computer program product of claim 1, wherein the web page code includes a Java servlet.

9. The computer program product of claim 1, wherein the instructions are included in a web browser, web browser plug-in, or Java plug-in.

10. The computer program product of claim 1, further comprising:
instructions for allowing the user the option to manually enter an electronic message address instead of selecting any electronic message address that was identified and obtained.

11. The computer program product of claim 1, further comprising:
instructions for detecting initiation of an electronic mail form on a website active in a browser; and
instructions for identifying and obtaining an electronic mail address being used by the electronic mail form.

12. A method for obtaining an electronic message address associated with a web address, comprising:
identifying a target web address;
searching one or more sources in order to identify and obtain an electronic message address, wherein the one or more sources are selected from content of a website at the web address, a remote third party server containing an electronic message address registered in association with the root web address of the website, and a combination thereof;
initiating an electronic message template; and
inserting an identified electronic message address into the electronic message template as the destination address.

13. The method of claim 1, wherein the remote third party server is a Domain Name System server.

14. The method of claim 1, further comprising:
displaying each electronic message address identified and obtained; and
allowing a user to select which displayed electronic message address to insert into the electronic message template.

15. The method of claim 1, wherein the step of searching one or more sources includes searching the content of the website, and further includes the step of identifying code in the website implementing an electronic message form or an electronic message link.

16. The method of claim 4, further comprising:
locating an electronic message address within the identified code.

17. The method of claim 1, wherein the step of searching one or more sources includes querying the remote third party server only if an electronic message address is not identified and obtained from the website content.

18. The method of claim 1, further comprising:
allowing the user the option to manually enter an electronic message address instead of selecting any electronic message address that was identified and obtained.
